(19) United States
(12) Patent Application Publication
(10) Pub. No.: US 2014/0074923 A1
(43) Pub. Date: Mar. 13, 2014

(54) SELECTIVE CONTENT DISCLOSURE IN AN AD-HOC NETWORK BASED ON SOCIAL COHESION

(71) Applicants: Venugopal Vasudevan, Palatine, IL (US); Silviu Chiricescu, Chicago, IL (US); Jehan Wickramasuriya, St. Charles, IL (US); Joseph F. Wodka, Hoffman Estates, IL (US)

(72) Inventors: Venugopal Vasudevan, Palatine, IL (US); Silviu Chiricescu, Chicago, IL (US); Jehan Wickramasuriya, St. Charles, IL (US); Joseph F. Wodka, Hoffman Estates, IL (US)

(73) Assignee: GENERAL INSTRUMENT CORPORATION, Horsham, PA (US)

(21) Appl. No.: 13/610,957

(22) Filed: Sep. 12, 2012

(51) Int. Cl. G06F 15/16

(52) U.S. Cl. 709/204

(57) ABSTRACT

In a device that is a member of an ad-hoc group in a network, a method includes determining an encounter history of the device with other devices in the ad-hoc group and filtering content intended to be shared by the device with the ad-hoc group based on the encounter history. A device includes a network interface to communicate with other devices in an ad-hoc group of a network and a disclosure assessment agent to determine a disclosure factor for disclosure of content to the ad-hoc group based on an encounter history of the device with other devices in the ad-hoc group. The device further includes a disclosure filter agent to filter content intended to be shared with the ad-hoc group based on the disclosure factor.

### TECHNICAL FIELD

The present disclosure is related generally to communications networks and, more particularly, to controlled distribution of content by users in communications networks.

### BACKGROUND

Social-media applications have facilitated the distribution of media and other content among groups of users. In some instances, membership in a group is relatively static and can be limited via membership-access mechanisms. In such scenarios, a user can relatively accurately ascertain the likely recipients of content and self-filter shared content to limit the risk of exposure of personal information to unintended recipients. With the increasing prevalence of ad-hoc or peer-to-peer networks, such as those that may be formed by mobile-device users at a social event or otherwise in geographic proximity, a user often connects to other users with whom the user has little or no familiarity. As such, the user risks either exposing personal information to relative strangers or excessively self-censoring due to uncertainties as to the potential recipients of the content to be shared and thus undermining the community-building intent of such ad-hoc networks. Conventional solutions require cumbersome security schemes that rely on users explicitly identifying each other as authenticated, which schemes render the content-sharing process in an ad-hoc group far from effortless.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is a diagram illustrating an example ad-hoc group of devices in accordance with at least one embodiment of the present disclosure;

FIG. 2 is a data-flow diagram illustrating an example implementation of a device for selective sharing of content with an ad-hoc group based on social cohesion in accordance with at least one embodiment of the present disclosure;

FIG. 3 is a flowchart illustrating a method for selective disclosure of content to devices of an ad-hoc group based on social cohesion in accordance with at least one embodiment of the present disclosure;

FIG. 4 is a diagram illustrating an example scenario whereby the obfuscation applied to content to be shared by a device with an ad-hoc network is modified by the joining of a device to the ad-hoc network in accordance with at least one embodiment of the present disclosure;

FIG. 5 is a diagram illustrating an example scenario whereby the obfuscation applied to content to be shared by a device with an ad-hoc network is modified by the departure of a device from the ad-hoc network in accordance with at least one embodiment of the present disclosure; and

FIG. 6 is a diagram illustrating an example hardware configuration of a mobile device in accordance with at least one embodiment of the present disclosure.

### DETAILED DESCRIPTION

Turning to the drawings, wherein like reference numerals refer to like elements, techniques of the present disclosure are illustrated as being implemented in a suitable environment.

The following description is intended to convey a thorough understanding of the present disclosure by providing a number of specific embodiments and details involving selective disclosure of content by a user of a device to other devices in an ad-hoc group based on a measure of the social cohesion of the users represented by the devices in the ad-hoc group. It is understood, however, that the present disclosure is not limited to these specific embodiments and details, which are examples only, and the scope of the disclosure is accordingly intended to be limited only by the following claims and equivalents thereof. It is further understood that one possessing ordinary skill in the art, in light of known systems and methods, would appreciate the use of the invention for its intended purposes and benefits in any number of alternative embodiments, depending upon specific design and other needs.

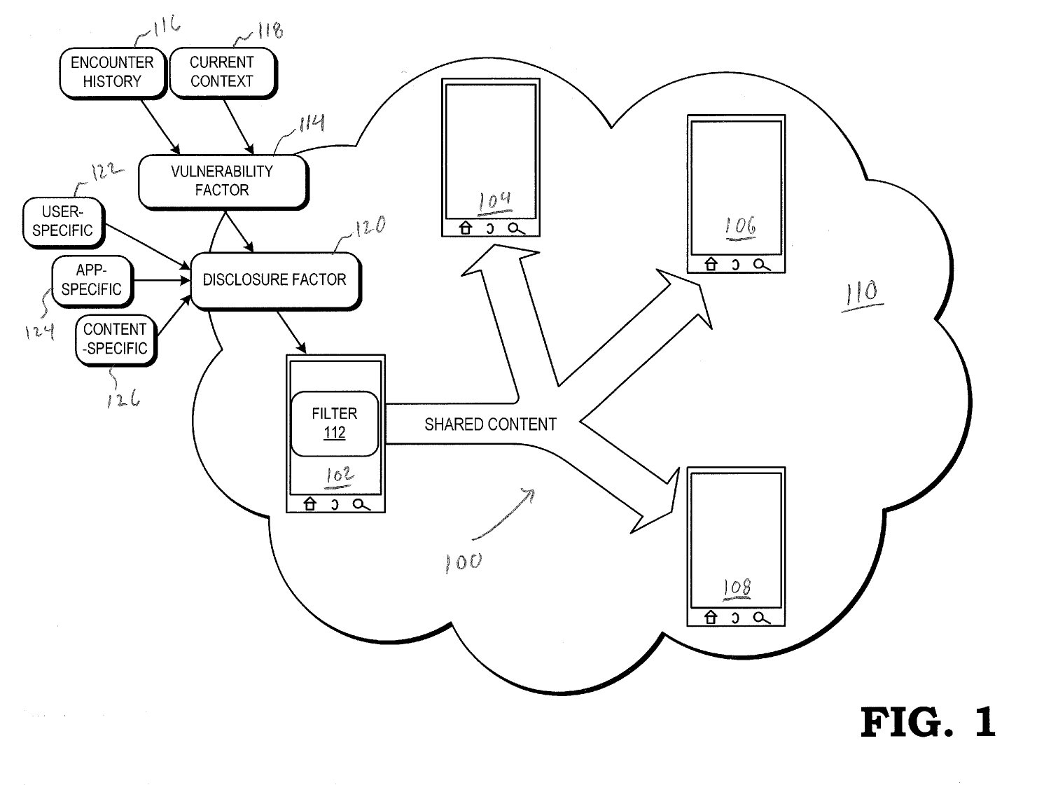

FIGS. 1 through 6 generally illustrate example devices and techniques for managing the degree of disclosure of content selected by a user of a device for dissemination to other devices in an ad-hoc group. In at least one embodiment, the user's device operates to identify the other devices (and thus other users) in the ad-hoc group and determines a vulnerability factor that is a measure of the likely social cohesion, or familiarity, between the user of the device and the users of the identified other devices in the ad-hoc group. This vulnerability factor reflects a user's likely degree of comfort in disclosing personal information to the other users in the ad-hoc network. As past interactions are relatively indicative of the intended tenor of present interactions, the device, in one embodiment, determines a vulnerability factor based in part on a history of encounters with the other devices in the ad-hoc network. This encounter history can include various encounter statistics regarding past encounters, such as the number or frequency of past encounters, the tenor of the encounters (e.g., the content type of the content previously disclosed between devices), the time elapsed since the last encounter, and other context of the past encounters (e.g., the time or geographical locations of the past encounters). The vulnerability factor further may be based on the current context of the ad-hoc group, such as the current time of day, current day of week, current geographical location, the time spent in the ad-hoc group, the number of members in the ad-hoc group, the rate of change in the number of members, etc.

The vulnerability factor reflects a coarse-grained measure of the user's familiarity with the other users in the ad-hoc group. However, the particular degree of comfort in sharing potentially personal information typically varies among users. For example, a gregarious person typically would be more comfortable with the risk of inadvertent disclosure of personal information to an unintended recipient than would a more reserved or private person. Moreover, users may have different expectations of privacy depending on the type of content to be shared. For example, users generally may expect more privacy regarding the breadth of dissemination of photographs compared to the breadth of dissemination of multicast text messages. Accordingly, in response to, or in anticipation of, a user's manipulation of the device to initiate the dissemination of content to the ad-hoc group, the device determines a disclosure factor by scaling or otherwise modifying the vulnerability factor based on one or more of a user-specific scale factor that represents a sharing-comfort level specified by the user, an application-specific scale factor that is specific to the software application that generated or provided the content to be shared, and a content-specific scale factor that represents a sharing-comfort level specific to the type of content to be shared.

When the user signals an intent to share content, the device filters data representative of the content to be shared using the disclosure factor before transmitting the filtered data to the other devices of the ad-hoc group. In at least one embodiment, the disclosure factor controls a degree or type of obfuscation applied to the shared content, whereby content can be obfuscated by, for example, removing a content element representative of certain content (e.g., preventing the transmission of photographs that depict faces), modifying a content element to obfuscate information potentially conveyed by the original content element (e.g., reducing a resolution of an image to be transmitted, removing user names or other identifiers from text messages, replacing certain terms in text messages with other terms, or removing certain terms altogether). In at least one embodiment, the user's device determines and employs the disclosure factor to filter shared content in a manner that does not require user input each time the user selects content for sharing with others in the ad-hoc group, thereby allowing the user to share content without resorting to the hassle of encryption, authentication, or one-to-one bonding for each content-sharing experience. Moreover, by relying on an encounter history of the device with the other devices in the ad-hoc group, the device can develop a reasonably accurate estimate of the familiarity of the user with the other users in the ad-hoc group and therefore can filter content based on this estimate without relying on access to third-party or external indicia of social cohesion among the users, such as other social-media applications, membership lists, organization lists, and the like.

Although techniques are described in the context of filtering content shared by a user so as to reduce the risk of disclosure of personal information to unintended recipients, these techniques can be similarly used to conditionally adapt the delivery of content in other scenarios. For example, such techniques may be implemented in a portable or public advertising display that adapts or modifies advertising content to the history of encounters the advertising display has had with mobile devices that have passed by the display or have otherwise been collocated with the display. As another example, the techniques can be implemented in a machine-to-machine situation whereby a device may determine its relative familiarity with proximate devices and send informational messages or reconfigure itself in a manner appropriate to the level of familiarity of nearby devices. Moreover, while these techniques can be employed by a variety of types of wired or wireless devices and in a variety of networks, the techniques are described in example contexts involving mobile wireless devices and ad-hoc, or peer-to-peer, networks for ease of illustration.

FIG. 1 illustrates an example ad-hoc group 100 employing selective disclosure of user content based on social cohesion in accordance with at least one embodiment of the present disclosure. In the depicted example, the ad-hoc group 100 comprises a plurality of mobile devices, such as mobile devices 102, 104, 106, and 108, connected via a network 110. The mobile devices 102, 104, 106, and 108 (collectively, “mobile devices 102 through 108”) can include any of a variety of mobile or portable wireless networked devices, such as wireless networked notebook computers, tablet computers, cellular phones, personal digital assistants, media players, portable game systems, and the like. The network 110 can comprise an ad-hoc network or a peer-to-peer wireless network formed by the mobile devices 102 through 108 in accordance with, for example, a WiFi Direct™ specification or a Bluetooth™ specification. In such instances, the ad-hoc group 100 and the network 110 may be co-extensive (that is, membership in the network 110 defines membership of the ad-hoc group 100). Alternatively, the network 110 can comprise an infrastructure wireless network, such as a local area network formed using an access point in accordance with, for example, one of the International Institute of Electronic and Electrical Engineers (IEEE) 802.11x specifications. In these instances, membership in the infrastructure wireless network may define membership in the ad-hoc group 100, or the ad-hoc group 100 may be formed from a subset of the devices in the infrastructure wireless network.

The ad-hoc group 100 can be formed in any of a variety of scenarios. The ad-hoc group 100 could be created by mobile-device users attending, for example, the same social event, such as a musical festival, party, art show, etc. As another example, a project team may form the ad-hoc meeting at the workplace during a meeting to communicate information regarding a project. The formation of the ad-hoc group 100 may be initiated by express input from the users of the mobile devices, such as through a software application that facilitates the formation of ad-hoc groups through a login page, or the formation may be automatically initiated by the proximity of the user's mobile devices (e.g., by joining a peer-to-peer network).

A primary purpose for forming an ad-hoc group is so that content may be broadly disseminated among members of the ad-hoc group. However, as an ad-hoc group typically has a dynamic membership, the users generally are unable to preconfigure disclosure settings so that the content shared with an ad-hoc group is tailored to the particular group membership at the time when the content is shared. For example, a user may be comfortable sharing photographs from the user's vacation in an ad-hoc group when the user's friends are the only members of the ad-hoc group, but when a stranger joins the ad-hoc group, the user may then prefer to share only those pictures that do not depict the user. Accordingly, one or more of the mobile devices 102 through 108 are configured dynamically and adaptively self-regulate the type and fidelity of content they disclose to other devices in the ad-hoc group 100 based on a measure of the social cohesion of the corresponding user with the other users in the ad-hoc group 100, whereby the social cohesion can be reflected in the extent and context in which the mobile device of the user has previously engaged with the other mobile devices (and thus the other users) in proximity.

To illustrate using mobile device 102 as an example, the mobile device 102 can employ a content filter 112 that filters content (representative of potentially personal information) intended to be shared with the mobile devices 104, 106, and 108 based on a vulnerability factor 114 that represents a likely social cohesion, or familiarity, of the user of the mobile device 102 with the users of the mobile devices 104, 106, and 108 in the ad-hoc group 100. The mobile device 102 determines the vulnerability factor 114 based on a variety of indicia of user familiarity with other users in the ad-hoc group 100, including an encounter history 116 that represents histories of encounters of the mobile device 102 with the other mobile devices in the ad-hoc group 100. The encounter history 116 maintained by the mobile device 102 can reflect various encounter statistics and contexts of previous encounters with other mobile devices. Table 1 below is a non-limiting list of examples of encounter statistics that may be maintained by a mobile device. These encounter statistics may be maintained on a per-device basis, cumulatively for all encountered devices, or both.

TABLE 1
Examples of Encounter Statistics Maintained in Encounter History

| Encounter Statistics | Examples |
|---|---|
| The number of previous encounters | Number of previous encounters in |
| withthe other mobile device | last year, last month, last week, |
| | last 24 hours, etc. |
| The frequency of previous | Average number of encounters per |
| encounters with the mobile device | week in the previous year |
| The locations of previous | Geographical location |
| encounters | Location type, e.g., work vs. home |
| | Network identifier, e.g., SSID |
| The durations of previous | The duration connected with the |
| encounters | other mobile device |
| | The duration of content exchange |
| | with the other mobile device |
| The content shared in previous | The content type of content to be |
| encounters | shared |
| | Frequency of content sharing |
| | Occurrence of a particular content |
| | item |
| | Obfuscation levels applied to |
| | previously shared content |

While the encounter statistics may be maintained on a per-encounter basis, in some instances it may be beneficial to employ encounter aggregation heuristics that recognize situations whereby a user may frequently encounter another user due to close proximity or mobility, but whereby each such encounter does not truly represent “an encounter” for the purpose of determining user familiarity. To illustrate, two users may work together in an office and may thus may encounter each other ten times, for example, as they go about their work during an eight-hour work period. Rather than treat each such instance as a separate encounter, and thus log ten separate encounters between the users for that day, the users' mobile devices may employ a filter or aggregation algorithm that takes note of the clustering of these “mini-encounters” and instead counts the entire encounter cluster as a single encounter having a duration of, for example, the eight-hour work day.

Moreover, in recognition that certain encounters are more important or more significant from a perspective of indicated familiarity, a mobile device may employ encounter-scoring heuristics to weigh certain encounters more heavily in the familiarity assessment. For example, encounters of a greater duration (e.g., encounters at the office) typically are indicative of a more important or significant relationship with the mobile device user, whereas encounters of a shorter duration (e.g., brief encounters at a coffee shop) typically indicate a less important or less significant relationship. Accordingly, the mobile device may also maintain statistics pertaining to the durations of the encounters so that this information may be used to determine the social cohesion in a given ad-hoc group.

The indicia of user familiarity used by the mobile device 102 to determine the vulnerability factor 114 further can include current context statistics 118 for the ad-hoc group 100. The current context statistics 118 maintained by the mobile device 102 can reflect various statistics for the ad-hoc group 100. As such, the vulnerability factor 114 reflects a coarse-grained representation of a general user's familiarity or social cohesion with the users of the other mobile devices in the ad-hoc group 100. Table 2 below is a non-limiting list of examples of such statistics that may be maintained by a mobile device.

TABLE 2
Examples of Current Context Statistics

| Current Context Statistic | Examples |
|---|---|
| Number of devices in ad-hoc | The largest number of devices in the |
| group | ad-hoc group over the last hour, the |
| | last day, etc. |
| | The smallest number of devices in the |
| | ad-hoc group over the last hour, the |
| | last day, etc. |
| | The average number of devices in the |
| | ad-hoc network over the last hour, over |
| | the last day, over the last week, etc. |
| | The current number of devices in the |
| | ad-hoc group |
| Rate of change in number of | Rate of change over a specified period |
| devices in ad-hoc group | Rate of change in membership exceeds |
| | a threshold |
| Joining/departure of devices | New device joined the ad-hoc network |
| | in the last period of time |
| | New device left the ad-hoc network in |
| | the last period of time |
| Location of ad-hoc group | Geographical location |
| | Location type, e.g., work vs. home |
| | Network identifier, e.g., SSID |
| Temporal | Day of week |
| | Time of day |
| | Date |

In at least one embodiment, the vulnerability factor 114 can be scaled or otherwise modified based on a variety of scale factors that reflect the particular circumstances of the user or of the context of the content to generate a disclosure factor 120 that represents a finer-grained representation of the specific user's comfort level with disclosing potentially personal information with the users of the other mobile devices in the ad-hoc group 100.

Such scale factors can include, for example, a user-specific scale factor 122 that is preconfigured by the user of the mobile device 102 to represent the user's particular perspective or preferences on the risk of disclosure of potentially personal information to unintended recipients. A more extroverted user may chose to set the user-specific scale factor 122 to permit a greater risk of disclosure of personal information, whereas a more introverted or private user may chose to set the user-specific scale factor 122 to limit the risk of disclosure of personal information. In at least one embodiment, the user-specific scale factor 122 is set by the user as a global user-specific scale factor to apply on a device-wide basis, that is, across various applications of the mobile device 102 that may share content with an ad-hoc group. In other embodiments, the user may set a different user-specific scale factor 122 on a per-content-type basis, on a per-application basis, or on a combination thereof.

The scale factors used to modify the vulnerability factor 114 to generate the disclosure factor 120 also can include an application-specific scale factor 124 that is preconfigured by a developer or provider of an application to apply to all content data generated by or otherwise provided by the application. For example, a developer of an application targeted to facilitating communication between social peers may elect to set a application-specific scale factor 124 that skews the resulting disclosure factor 120 to a less conservative filtering of content, whereas an application targeted to a business audience may select to set an application-specific scale factor 124 that skews the resulting disclosure factor 120 to a more conservative filtering of content. A content-specific scale factor 126 likewise may be used to generate the disclosure factor 120, whereby the content-specific scale factor 126 is preconfigured for a particular content type. To illustrate, text messages may be deemed to have a lower risk for disclosure of personal information than images, and thus the content-specific scale factor 126 configured for a text-message type of content may modify the resulting disclosure factor 120 to reduce the level of obfuscation applied to text messages to be shared, whereas the content-specific scale factor 126 configured for an image type of content may modify the resulting disclosure factor 120 to increase the level of obfuscation applied to images to be shared.

The vulnerability factor 114 and disclosure factor 120 may be represented in any of a variety of ways. One way of implementing these factors could be a value on a scale of, for example, 0 to 5, whereby a vulnerability factor 114 having a value of 0 indicates that the user is determined to be intimately familiar with all of the users in the ad-hoc group 100 (that is, there is extremely high social cohesion), and a disclosure factor 120 having a value of 0 indicates that there is to be unrestricted disclosure (that is, no filtering). Conversely, a vulnerability factor 114 having a value of 5 in this example indicates that the other users in the ad-hoc group 100 are determined to be strangers, and a disclosure factor 120 having a value of 5 indicates the highest restriction on disclosure (that is, filtering with the highest level of obfuscation). It should be noted that embodiments described herein are described in a context whereby the more general vulnerability factor 114 is modified based on user- and content-specific scale factors to generate a more user and content-specific disclosure factor 120, which is then used to control the degree of filtering implemented by the content filter 112. However, in other embodiments, the vulnerability factor 114 may be used in its unmodified form to control the filtering of content to be shared. In such instances, the vulnerability factor 114 acts as the disclosure factor 120 (that is, the vulnerability factor 114 is the disclosure factor 120).

The content filter 112 can use any of a variety of obfuscation techniques to filter the shared data based on the disclosure factor 120. Such obfuscation techniques can include, for example, removing or preventing transmission of certain types of content, modifying content elements to reduce the fidelity of the content, substituting certain content elements for other more-general or less-personal content elements, and the like. For example, text messages (one example of content) to be multicast to the other mobile devices can be selectively modified based on the disclosure factor 120 to remove terms that reference the user's identity, gender, age, etc. As another example, a disclosure factor 120 indicating that the user is very familiar with all of the other users may cause the content filter 112 to permit all photographs to be shared, a disclosure factor 120 indicating that the user is only somewhat familiar with the most of the other users may cause the content filter 112 to render the photographs at a lower resolution before sharing, and a disclosure factor 120 indicating the user is unfamiliar with most of the other users may cause the content filter 112 to block the sharing of photographs that depict human faces. In this manner, the type and level of obfuscation implemented by the content filter 112 for filtering content is controlled by the disclosure factor 120.

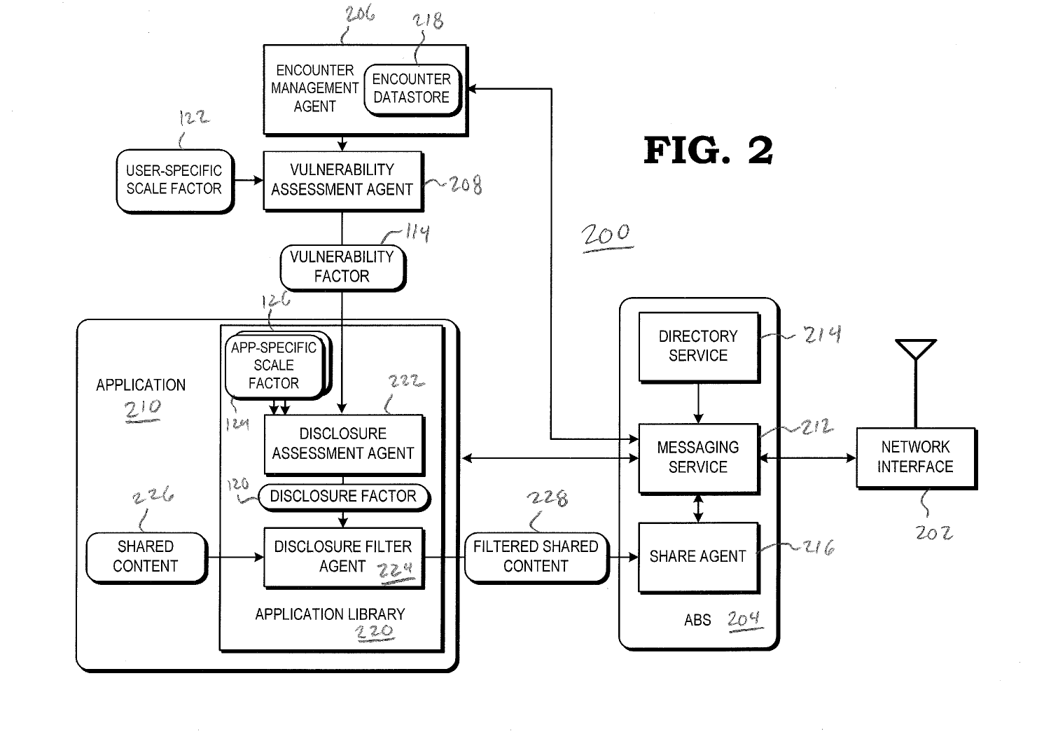

FIG. 2 illustrates an example configuration of a mobile device 200 for employing this adaptive self-regulation of the type and fidelity of shared content. The mobile device 200 represents, for example, the mobile device 102 of FIG. 1. As shown, the mobile device 200 includes a network interface 202, an automatic beaconing system (ABS) 204, an encounter-management agent 206, a vulnerability-assessment agent 208, and one or more content-sharing applications 210. The network interface 202 can include, for example, an IEEE 802.11-compliant wireless network interface, a Bluetooth™-compliant wireless network interface, and the like. The functionality of the ABS 204 and the agents of the mobile device 200, as described below, may be implemented using dedicated hardware, in software executing on one or more processors (not shown), or a combination thereof.

The ABS 204 manages the sharing of content with other mobile devices in the ad-hoc group 100 via the network interface 202. For example, in at least one embodiment, the ABS 204 implements the Internet Engineering Task Force Zero Configuration (Zeroconf) protocol to enable the mobile device 200 to broadcast and subscribe to proximate devices identified in the immediate vicinity and develop a device map of such identified proximate devices. To this end, the ABS 204 includes a messaging service 212, a directory service 214, and a share agent 216. The messaging service 212 manages the mobile device's participation in a peer-to-peer or ad-hoc network, including the transmission and reception of beacon messages, the transmission and reception of service publish or subscription messages, the transmission and reception of available services, and the like.

The messaging service 212 can utilize any of a variety of peer-to-peer network protocols, including the aforementioned Zeroconf protocol, the Universal Plug-and-Play Protocol, the Bonjour protocol promulgated by Apple, Inc., and the like. Such protocols typically utilize a suite of features, including link-local addressing to automatically assign Internet Protocol addresses and a domain name service-service discovery protocol to discover and identify other ad-hoc networking-enabled devices in the area. To facilitate this operation, the directory service 214 maintains a directory of mobile devices in the ad-hoc group 100 and enables the messaging service 212 to multicast to the mobile devices in the ad-hoc group 100 using, for example, a multicast domain name service, such as the Multicast DNS promulgated by Apple, Inc., or the Link-Local Multicast Name Resolution promulgated by Microsoft, Inc. The share agent 216 formats content for distribution to the other mobile devices of the ad-hoc group 100 via the messaging service 212 as described in greater detail below.

The encounter-management agent 206 operates to maintain an encounter datastore 218 that stores statistical information pertaining to previous encounters of the mobile device 200 with other mobile devices. The encounter datastore 218 can be implemented as a database, a table, a matrix or array, or other data structure or combination of data structures. To maintain the encounter datastore 218, the encounter management agent 206 monitors incoming and outgoing messages communicated by the messaging service 212 to identify other mobile devices encountered, identify statistical information regarding content shared with other encountered mobile devices and regarding content shared by other encountered mobile devices with the mobile device 200 (such as, for example, the type of content shared or the frequency of content shared), current contextual information such as the number of mobile devices in the ad-hoc group 100 at particular times or when content is shared, and the like. Table 3 below illustrates a non-limiting example list of encounter statistics that may be maintained in the encounter datastore 218.

TABLE 3
Example of Statistical Information Maintained
in the Encounter Datastore

| Device-Specific Statistical | |
|---|---|
| Information | General Statistical Information |
| Number of encounters with other device | Number of other mobile devices |
| in a preceding specified period (e.g., | currently in ad-hoc group |
| hour, day, week, month, etc.) | |
| Number of content items shared with | Rate of change of membership |
| other device in a preceding specified | in ad-hoc group |
| period | |
| Types of content shared with other | Number of other mobile devices |
| device | encountered in the preceding |
| | specified period |
| Number of content items shared by | Number of content items shared |
| other device in a preceding | with other mobile devices in |
| specified period | specified period |
| Types of content shared by other device | Number of content items shared |
| | by other mobile devices in |
| | specified period |
| Time since content item of specified | |
| type last shared with other device | |

The vulnerability-assessment agent 208 operates to dynamically calculate the vulnerability factor 114 based on current conditions of the ad-hoc group 100, including the encounter history 116 (see FIG. 1) of the mobile device 200 with the other mobile devices currently in the ad-hoc group 100 and based on the current context statistics 118 (see FIG. 1) of the ad-hoc group 100 (e.g., the time of day, the location of the ad-hoc group 100, the rate of change of membership in the ad-hoc group 100, etc.). To this end, the vulnerability-assessment agent 208 has access to the encounter statistical information stored in the encounter datastore 218 for use in calculating the vulnerability factor 114 for the ad-hoc group 100. An example algorithm that may be implemented by the vulnerability-assessment agent 208 to calculate the vulnerability factor 114 is described in greater detail below.

Moreover, as noted above, a user-specific scale factor 122 that represents a tolerance for risk of disclosure of personal information of the user of the mobile device 200 may be used in generating the vulnerability factor 114. The vulnerability-assessment agent 208 then may determine a raw vulnerability factor based on an application of a specified vulnerability algorithm to the encounter history 116 and the current context statistics 118 of the ad-hoc group 100. This raw vulnerability factor then may be scaled by the user-specific scale factor 122 to generate the final vulnerability factor 114 as represented by, for example, the following equation (1):

final_vulnerability=raw_vulnerability*user_factor

where final_vulnerability represents the vulnerability factor 114, raw_vulnerability represents the raw vulnerability factor, and user_factor represents the user-specific scale factor 122.

To illustrate, during a setup of the mobile device 200 or during setup of a content-sharing application on the mobile device 200, the user may be prompted to provide an indication of the user's preferred general degree of shared content filtering via, for example, three options: conservative (0.75); moderate (1.0); and open (1.25), and the user's selected option may be stored in a register or other storage element of the mobile device 200 as the user-specific scale factor 122. Upon determining a raw vulnerability factor for the ad-hoc group 100, the vulnerability-assessment agent 208 scales by either 0.75, 1.0, or 1.25 based on the user's indicated preference to generate the vulnerability factor 114.

In at least one embodiment, the vulnerability factor 114 determined by the vulnerability-assessment agent 208 provides a coarse assessment of the social cohesion of the user of the mobile device 200 with the users of the other mobile devices in the ad-hoc group 100. As such, the same vulnerability factor 114 can be applied across all of the content-sharing applications of the mobile device 200, and each content-sharing application may further refine the vulnerability factor 114 based on content-specific or application-specific factors to generate a corresponding disclosure factor 120 that is used to control the degree of filtering applied to content to be shared by that content-sharing application.

To illustrate, the content-sharing application 210 includes an application library 220 that implements a disclosure assessment agent 222 and a disclosure filter agent 224 that together determine the disclosure factor 120 for the application 210 from the supplied vulnerability factor 114 and use the disclosure factor 120 to filter content to be shared. The application library 220 can comprise a library of pre-compiled code, subroutines, application programmer interfaces (APIs), or other software components executed in conjunction with one or more processors. The disclosure assessment agent 222 receives the current vulnerability factor 114 from the vulnerability-assessment agent 208 and determines the disclosure factor 120 based on the current vulnerability factor 114 and one or more scale factors specific to the content-sharing application 210, such as an application-specific scale factor 124 that applies for all content generated or otherwise provided by the content-sharing application 210 or a content-specific scale factor 126 that applies to the particular type of content selected by the user for sharing with the ad-hoc group 100. This disclosure assessment agent 222 can generate the disclosure factor 120 by scaling the vulnerability factor 114 by the application-specific scale factor 124 and by the content-specific scale factor 126 using, for example, the following equation (2):

disclosure_factor=final_vulnerability*app_factor*content_factor

where disclosure_factor represents the disclosure factor 120, final_vulnerability represents the vulnerability factor 114, app_factor represents the application-specific scale factor 124, and content_factor represents the content-specific scale factor 126 for the type of content to be shared.

These scale factors may be configured by one of, or a combination of, the user, a developer or distributor of the content-sharing application 210, a provider of the network 110 (see FIG. 1) in which the ad-hoc group 100 is operating, and the like. For example, the content-sharing application 210 may be capable of sharing both short messaging service (SMS) messages and multimedia messaging service (MMS) messages, and the developer of the content-sharing application 210 may have concluded that users of the content-sharing application 210 are more comfortable with openly sharing SMS messages than MMS messages and thus sets a default content-specific scale factor 126 for SMS-type messages at 0.90 and a default content-specific scale factor 126 for MMS-type messages at 0.7.

The disclosure filter agent 224 operates to filter content based on the disclosure factor 120 before providing the content to the share agent 216 for sharing with the other mobile devices in the ad-hoc group 100. When a user specifies content intended to be shared with the ad-hoc group 100 (this content referred to herein as “shared content 226”), the application 210 provides the shared content 226 to the disclosure filter agent 224. In response, the disclosure filter agent 224 accesses the current disclosure factor 120 and filters the shared content 226 based on the disclosure factor 120 to generate filtered shared content 228. The disclosure filter agent 224 provides the filtered shared content 228 to the share agent 216, which then coordinates with the messaging service 212 to multicast or otherwise disseminate the filtered shared data to the other mobile devices of the ad-hoc group 100 via the network interface 202. Because the context or membership of the ad-hoc group 100 may change, the vulnerability factor 114, and thus the disclosure factor 120, may be dynamically recalculated or updated to reflect the changed circumstances of the ad-hoc group 100.

The disclosure filter agent 224 can apply any of a variety of content obfuscation techniques to filter the shared content 226 based on the disclosure factor 120. For example, the disclosure filter agent 224 may provide multiple levels of obfuscation, whereby the particular level of obfuscation applied to the shared content depends on the magnitude of the disclosure factor 120. Obfuscation techniques applied at a particular level can include, for example, preventing certain content elements from being shared (e.g., preventing the sharing of images with human faces while permitting other types of images to be shared or removing user-identifying metadata from shared content), reducing the fidelity of the content or certain content elements (e.g., reducing the resolution of images to be shared), replacing certain content elements with less-specific content elements or otherwise modifying content to remove information (e.g., replacing certain terms or user-identifying information in a text message with more generic terms or editing a image to eliminate text originally depicted in the image).

To illustrate, the content-sharing application 210 may be a photo-sharing application, and the disclosure filter agent 224 can implement four levels of obfuscation: level 1, no obfuscation, share all images without modification; level 2, reduce the image fidelity (e.g., resolution or color range) of images before sharing; level 3, prevent transmission of images depicting human faces or depicting text; and level 4, prevent transmission of all images. Also in this example, assume that the levels are associated with the following ranges of the disclosure factor 120 on a 0.0 (complete non-familiarity) to 1.0 (complete familiarity) scale: level 1, 0.9 to 1.0; level 2, 0.6 to 0.8; level 3, 0.3 to 0.5; and level 4, 0.0 to 0.2. In this example, the disclosure filter agent 224 would prevent the sharing of a image depicting a human face for a calculated disclosure factor of 0.4, while allowing the sharing of the image with degraded fidelity for a calculated disclosure factor of 0.6.

In addition to, or instead of, employing obfuscation techniques to reduce the risk of unintended disclosure of personal information based on the estimated social cohesion of the user with the other users in the ad-hoc group 100, the disclosure filter agent 224 further can limit the potential unintended disclosure of personal information by specifying certain limitations on the dissemination of the filtered shared content 228. For example, the network protocol or software application employed to form the ad-hoc group 100 may enable limitations on the distribution of shared content by limiting the number of times the shared content may be retransmitted (that is, by specifying a maximum hop count), by providing an indicator of the maximum geographical range or time window in which the content may be shared, and the like. To this end, the disclosure filter agent 224 can provide to the share agent 216 signaling to identify those dissemination limitation features to be employed for the filtered shared content 228. As with the obfuscation techniques, the disclosure filter agent 224 can select the dissemination limitation features to be used for the filtered shared content 228 based at least in part on the disclosure factor 120. Thus, dissemination features may be employed more aggressively for disclosure factors 120 indicating a lower degree of social cohesion and less aggressively for disclosure factors 120 indicating a higher degree of social cohesion.

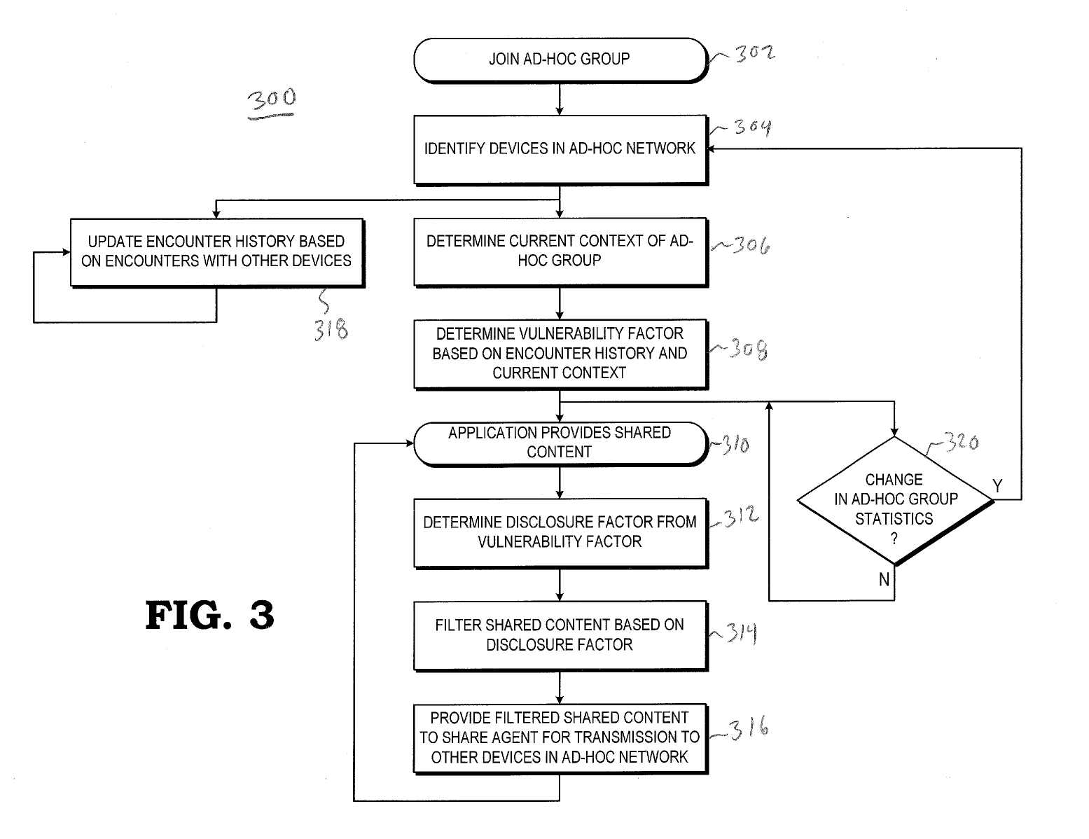

FIG. 3 illustrates an example method 300 of operation of a mobile device for sharing content with other devices in an ad-hoc group in accordance with at least one embodiment of the present disclosure. For ease of illustration, the method 300 is described in the example context of the mobile device 200 of FIG. 2 and the ad-hoc group 100 of FIG. 1. The method 300 initiates at block 302, whereby the mobile device 200 joins the ad-hoc group 100. The process of joining the ad-hoc group 100 may include, for example, the messaging service 212 transmitting a discovery beacon via the network interface 202 and receiving assignment of an Internet Protocol address. At block 304, the mobile device 200 identifies the other devices in the ad-hoc group 100 by, for example, monitoring for discovery beacons from other devices and building a device directory of discovered devices via the directory service 214.

At block 306, the vulnerability assessment agent 208 determines the current context statistics 118 of the ad-hoc group 100, which can include various statistics such as the current time of day, the current day of week, the current date, the location of the ad-hoc group 100, the number of members currently in the ad-hoc group 100, and the like. At block 308, the vulnerability assessment agent 208 uses the current context statistics 118 and the encounter history 116 for the devices identified at block 304 to determine the user's likely familiarity or social cohesion with the members of the ad-hoc group 100 in the form of the vulnerability factor 114. As noted above, the vulnerability assessment agent 208 may determine a raw vulnerability factor based on the encounter history 116 and on the current context statistics 118 and then scale or otherwise modify the raw vulnerability factor based on a user-specific scale factor 122 programmed by the user to generate the vulnerability factor 114. The algorithm used to determine the vulnerability factor 114 from the current context statistics 118 and the encounter history 116 can take any of a variety of forms and typically is implementation specific.

At block 310, the user interacts with the content-sharing application 210 to identify shared content 226 intended by the user to be shared with the ad-hoc group 100. In response, at block 312 the disclosure assessment agent 222 determines the disclosure factor 120 from the vulnerability factor 114. In one embodiment, the disclosure assessment agent 222 scales or otherwise modifies the vulnerability factor 114 by one or more application-specific scale factors 124 for the content-sharing application 210 or one or more content-type-specific scale factors 126 for the type of content being shared to generate the disclosure factor 120.

At block 314, the disclosure filter agent 224 filters the shared content 226 based on the disclosure factor 120 to generate the filtered shared content 228. The filtering performed by the disclosure filter agent 224 can include applying one or more information-obfuscation techniques, such as removing content elements, replacing content elements with more general content elements, or degrading the information content of content elements, based on the value or level range of the disclosure factor 120. Moreover, the filtering performed by the disclosure filter agent 224 can include the implementation of one or more dissemination-limitation mechanisms, such as setting a maximum hop count for retransmission of the filtered shared content 228 or limiting the retransmission of the filtered shared content 228 to a specified geographical area, a specified network or subnetwork, by limiting the time period in which the filtered shared content 228 may be retransmitted, and the like. At block 316, the disclosure filter agent 224 provides the filtered shared content 228 and any control information for the dissemination-limitation mechanisms to be employed to the share agent 216, which then formats the filtered shared content 228 into one or more messages to be multicast, broadcast, or otherwise disseminated to the identified devices in the ad-hoc group 100 via the network interface 202.

As noted above, the social cohesion of the ad-hoc group 100 typically is fluid, and thus the mobile device 200 may dynamically update the disclosure factor 120 to reflect the current measure of social cohesion of the ad-hoc group 100. Accordingly, in parallel with the process of blocks 304 through 316, at block 318 the encounter-management agent 206 can update the encounter history 116 based on recent encounters with other devices by monitoring the devices joining and leaving the ad-hoc group 100 and monitoring the content being shared by the mobile device 200 and being shared with the mobile device 200 and updating the encounter datastore 218 accordingly. Likewise, at block 320 the vulnerability-assessment agent 208 can monitor the encounter datastore 218 to determine whether the statistics representing the context of the ad-hoc group 100 have sufficiently changed to justify an update or recalculation of the vulnerability factor 114 (and thus triggering a revision to the resulting disclosure factor 120 generated by the disclosure assessment agent 222). Alternatively, the vulnerability assessment agent 208 can revise the vulnerability factor 114 on a specified schedule.

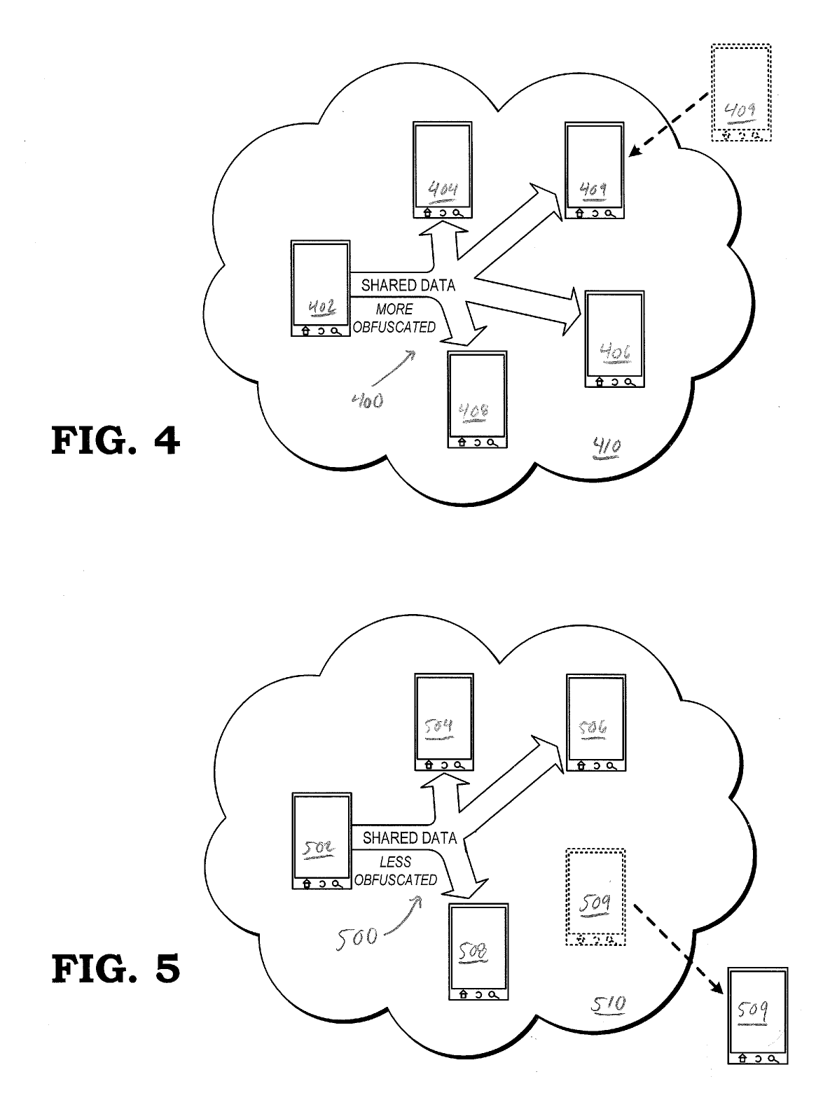

FIGS. 4 and 5 illustrate example scenarios for selective sharing of content in an ad-hoc group based on an assessment of the social cohesion of the ad-hoc group in accordance with the techniques described above. In the example illustrated by FIG. 4, an ad-hoc group 400 is formed in a peer-to-peer network 410 at a large social event, such as an art show. Initially, the ad-hoc group 400 includes the mobile devices 404, 406, and 408 of the friends of the user of mobile device 402 for the purposes of sharing photographs and text messages regarding the social event among the ad-hoc group 400 via a content-sharing application, and thus the encounter history 116 maintained by the mobile device 402 shows extensive encounter histories with the mobile devices 404, 406, and 408. As such, the vulnerability factor 114 calculated for the ad-hoc group 400 initially indicates a high-degree of social cohesion. Accordingly, the initial disclosure factor 120 calculated by the content-sharing application at the mobile device 402 permits the user of the mobile device 402 to share content with the mobile devices 404, 406, and 408 without obfuscation.

However, in this example a mobile device 409 operated by a stranger to the user of the mobile device 402 joins the ad-hoc group 400. In response to detecting this change in the membership of the ad-hoc group, the mobile device 402 recalculates the vulnerability factor 114 under this new context. As the mobile device 402 has not encountered the mobile device 409 before, the vulnerability factor 114 is modified to reflect the lack of an encounter history with the mobile device 409 and thus indicate that there is now less social cohesion in the ad-hoc group 400. Thus, when the user of the mobile device 402 acts to share content after the mobile device 409 has joined the ad-hoc group 400, the content-sharing application recalculates the disclosure factor 120 based on the revised vulnerability factor 114. As the revised vulnerability factor 114 reflects a decreased level of familiarity, the recalculated or revised disclosure factor 120 correspondingly will reflect an application of a higher degree of obfuscation in shared content. Accordingly, the mobile device 402 would then apply one or more obfuscation techniques to the photograph of the user, such as reducing the resolution of the photograph, removing any tags embedded in the photograph or replacing certain tags with more generic tags, preventing the transmission of the photograph, and the like.

FIG. 5 illustrates an example scenario whereby an ad-hoc group 500 is formed in a peer-to-peer network 510 at a work site. Initially, the ad-hoc group 500 includes the mobile devices 504, 506, and 508 of the colleagues of the user of mobile device 502 for the purposes of sharing text messages regarding the status of a sensitive work project. The ad-hoc group 500 also initially includes a mobile device 509 of a contractor who does not regularly interact with the other members of the ad-hoc group, and thus the encounter history maintained by the mobile device 502 shows extensive encounter history with each of the mobile devices 504, 506, and 508 and a relatively infrequent encounter history with the mobile device 509. As such, the vulnerability factor 114 calculated for the ad-hoc group 500 initially indicates a moderate-degree of social cohesion. Accordingly, the initial disclosure factor 120 calculated by the content-sharing application at the mobile device 502 causes the mobile device 502 to moderately filter content shared by the user of the mobile device 502. This filtering can include, for example, removing user-identifying tags or names from the text messages so as to obfuscate the source of the text messages or preventing transmission of text messages that may have off-color content.

Further in this example, the contractor operating the mobile device 509 leaves the work site and thus leaves the ad-hoc group 510. In response to detecting this change in the membership of the ad-hoc group 510, the mobile device 502 recalculates the vulnerability factor 114. As all of the remaining mobile devices have an extensive encounter history with the mobile device 502, the vulnerability factor 114 is modified to indicate that there is now a higher degree of social cohesion in the ad-hoc group 500. Thus, when the user of the mobile device 502 acts to share content after the mobile device 509 has left the ad-hoc group 500, the content-sharing application recalculates the disclosure factor 120 based on the revised vulnerability factor 114. As the revised vulnerability factor 114 reflects an increased level of familiarity, the recalculated disclosure factor 120 correspondingly will reflect an application of a lower degree of obfuscation in shared content, such as by permitting user-identifying tags to be transmitted with text messages or by permitting text messages with off-color content to be shared.

### Example Algorithm for Calculating a Disclosure Factor for an Ad-Hoc Group

As noted above, a goal of evaluating the social cohesion of an ad-hoc group is to determine an obfuscation level suitable for sharing content between devices of the ad-hoc group. For the following, it is assumed that there are a finite number L of obfuscation levels E1, E2, . . . , and EL. It is also assumed that each device in the ad-hoc group is capable of providing Sk services, whereby a service can include provision of certain content or provision of a certain type of content (e.g., providing Sk types of content). Formally, a device nk is associated with the following tuple {sjk, pkj}, j=1 to Sk, where pkj is the port onto which service sjk is being offered.

When a device receives a request for a service, it first determines the obfuscation level (as represented by the disclosure factor) that it is going to use to provide that content. The obfuscation level is determined by the device that provides the content based on the other devices in the current ad-hoc group and the history of requests received during a certain period.

For each service sjk it provides, a device nk keeps a list of requests that have been made for the particular service during a period of time T. That list contains the following tuple {ni, Ta, Ej}, where ni is the device that has requested the service (i.e., sjk), Ta is the time stamp when the service has been requested or provided, and Ej is the obfuscation level used when the service was “delivered” (e.g., the requested content was shared). Note that this list is being constantly updated as there is a time component associated with it.

For each service sjk of a device nk, a service network graph Gkj (V, E) representing the ad-hoc group, where V is the set of vertexes and E is the set of directed edges, is maintained. V represents the nodes (devices) in the ad-hoc group, and an edge eki exists if and only if (iff) device ni has requested service sjk from device nk. In other words, device ni must appear in the tuple list maintained by device nk for service sjk. The weight wik of the edge eki (that is, the disclosure factor) is determined according to the following equation (3):

$${w}_{ik} = \frac{1}{M} {\sum }_{m = 1}^{M} exp ( \frac{- Tc + Tm}{Lm} )$$

where (i) M is the total number of times device nk has provided service sjk to device ni in the last period T, (ii) Lm is the obfuscation level used during the mth time the service has been delivered, and (iii) Tc is the current time. Note that wik is in the interval (0, 1]. The intuition behind equation (3) is as follows: The more recently the service sjk has been provided, the more “relevant” the obfuscation level used at that time. This is because of the implicit assumption that the current ad-hoc group context (e.g., the number of devices in the ad-hoc group and the familiarity between the devices) changes relatively slowly and thus the obfuscation level used in the more recent content communication exchanges are chosen to approximate the level of familiarity or trust present in the ad-hoc group at the current time. Also, the higher obfuscation level of a previous content communication, the higher the contribution to the weight calculation (given the same Tm). In other words, the higher the obfuscation level, the longer it is “remembered.”

Finally, if two devices in the service network graph Gkj are not connected by an edge, then it is assumed that the devices are not familiar or otherwise do not trust each other and that they have never exchanged services with each other. When computing the familiarity level for delivering service sjk to device ni by device nk, the following equation (4) is used iff eki is a member of E:

$${E}_{level} = \frac{L}{( \vert V \vert - 2 )} * {\sum }_{m = 1}^{( \vert V \vert - 2 )} {e}^{Wkm •} , m 1 = i$$

where Wkm is the weight of edge ekm if it exists (as calculated by equation (3)). If eki is not in E, then the obfuscation level used is the highest, and thus an “implicit” weight of 1 is assumed. Equation (4) takes into consideration all of the devices currently present in the network except for ni and nk.

When a device nk joins the ad-hoc group, it announces its presence by broadcasting the services it provides in the form described above. The other devices in the ad-hoc group use this broadcast message to update their corresponding service network graphs. Device nk then requests a list of all the services available in the ad-hoc group and makes that list available to the applications residing on it. From this request, the device nk constructs its service network graphs (Gkj (V, E)).

When the device nk receives a request for a service sjk, it first determines the level of obfuscation to use for the delivery of the service using equation (4). Assuming that the L levels of obfuscation are “equally distributed,” when calculating the weights of the service network graphs (using equation (1)), a value of 1/L for obfuscation level 1 (E1) may be used. Thus, for an example service network graph comprising devices A, B, and C in an ad-hoc group, assuming that device A has provided service s to device B only once in the past, and that the obfuscation level used at that time was E1, WAB may be calculated according to equation (5):

$${W}_{AB} = {e}^{- ( {T}_{C} - {T}_{AB} ) + L}$$

where TAB is the time when the service was provided and L is the total number of obfuscation levels.

According to equation (4), as soon as an unknown device enters the ad-hoc group, the obfuscation level used to communicate between any two devices in the ad-hoc group is increased. Likewise, as soon as the unknown device leaves the ad-hoc group, the obfuscation level decreases.

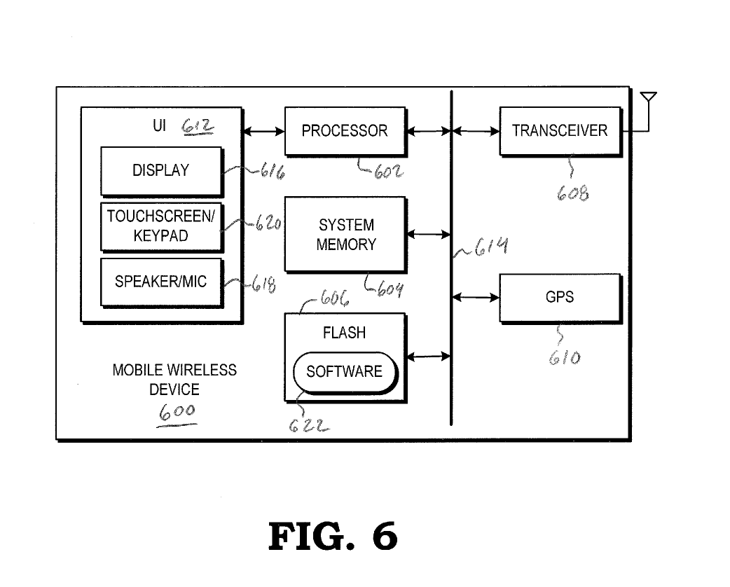

FIG. 6 illustrates an example hardware implementation of a wireless device 600 that may implement one of more of the selective content-sharing techniques described herein. The wireless device 600 may represent, for example, the hardware configuration of the mobile device 200 of FIG. 2. In the depicted example, the wireless device 600 includes a processor 602 (e.g., a central processing device), one or more memories, such as system memory 604 and flash memory 606, a wireless communication interface 608 (one embodiment of the network interface 202 of FIG. 2), a GPS device 610, and a user interface (UI) 612 connected via one or more busses 614 or other interconnects. The wireless communication interface 608 includes a radio frequency transceiver configured to establish a wireless connection with one or more other wireless devices. The UI 612 includes, for example, a display device 616 and a speaker/microphone device 618. The display device 616 includes a display and a display controller for processing image data received from the processor 602. The speaker/microphone device 618 includes a digital-to-analog converter and a speaker for outputting audio information from the processor 602 and a microphone and an analog-to-digital converter for providing audio information to the processor 602. The user interface 612 further includes keys, buttons, switches, and other user-manipulated input devices, such as a keypad or touch panel 620, to receive input from a user for processing at the processor 602. The GPS device 610 includes a GPS antenna system or other location-determination device for determining a location of the wireless device 600 and for providing a representation of the location to the processor 602.

The processor 602 executes a set of instructions stored at a computer-readable medium, such as the flash memory 606, whereby the set of instructions represent one or more software applications 622, which manipulate the processor 602 to perform various software-based functionality to implement at least a portion of the techniques described above, provide visual information via the display device 616, respond to user input via the user interface 612, and the like.

In view of the many possible embodiments to which the principles of the present discussion may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

We claim:

1. In a device that is a member of an ad-hoc group in a network, a method comprising:
determining an encounter history of the device with other devices in the ad-hoc group; and
filtering content intended to be shared by the device with the ad-hoc group based on the encounter history.

2. The method of claim 1:
further comprising determining a disclosure factor based on the encounter history and on a context of the ad-hoc group;
wherein filtering content intended to be shared with the ad-hoc group comprises filtering the content based on the disclosure factor, wherein a level of obfuscation of information employed by the filtering is based on the disclosure factor.

3. The method of claim 2:
further comprising revising the disclosure factor responsive to a change in membership in the ad-hoc group;
wherein filtering content intended to be shared by the device with the ad-hoc group is based on the revised disclosure factor.

4. The method of claim 2 wherein determining the disclosure factor comprises:
determining a vulnerability factor based on the encounter history; and
scaling the vulnerability factor by at least one scale factor to determine the disclosure factor.

5. The method of claim 4 wherein the at least one scale factor comprises an element selected from the group consisting of: a user-specific scale factor set by a user for the device, an application-specific scale factor set for an application executed by the device and associated with the content intended to be shared, and a content-type scale factor set at the device for a content type of the content intended to be shared.

6. The method of claim 1:
further comprising maintaining a datastore at the device, the datastore storing encounter statistics determined from encounters by the device with other devices;
wherein the device determines the encounter history using the datastore.

7. The method of claim 6 wherein the encounter statistics include, for an encountered other device, an element selected from the group consisting of: a number of previous encounters with the other device, a frequency of encounters with the other device, a number of previous exchanges of content between the device and the other device, a type of content previously exchanged between the device and the other device, and a time of a last exchange of content between the device and the other device.

8. The method of claim 1 wherein filtering the content intended to be shared with the ad-hoc group comprises an element selected from the group consisting of: removing a content element from the content, replacing a content element of the content with a more general content element, and modifying a content element of the content to obfuscate information potentially conveyed by the content element.

9. The method of claim 1:
wherein the device comprises a mobile device;
wherein the network comprises a mobile ad-hoc network;
the method further comprising wirelessly transmitting the filtered content to the devices of the ad-hoc network.

10. A device comprising:
a network interface to communicate with other devices in an ad-hoc group of a network;
a disclosure assessment agent to determine a disclosure factor for disclosure of content to the ad-hoc group based on an encounter history of the device with other devices in the ad-hoc group; and
a disclosure filter agent to filter content intended to be shared with the ad-hoc group based on the disclosure factor.

11. The device of claim 10:
further comprising a vulnerability-assessment agent to determine a vulnerability factor for the ad-hoc group based on the encounter history;
wherein the disclosure assessment agent is to scale the vulnerability factor by at least one scale factor to determine the disclosure factor.

12. The device of claim 11 wherein the at least one scale factor is selected from the group consisting of: a user-programmable device-specific scale factor set by a user for the device, an application-specific scale factor set for an application executed by the device and associated with the content intended to be shared, and a content-type scale factor set at the device for a content type of the content intended to be shared.

13. The device of claim 10 further comprising:
a datastore storing encounter statistics representing encounters by the device with other devices; and
an encounter-management agent to update the datastore responsive to interactions between the device and the other devices.

14. The device of claim 13 wherein the encounter statistics include, for an encountered other device, an element selected from the group consisting of: a number of previous encounters with the other device, a frequency of encounters with the other device, a number of previous exchanges of content between the device and the other device, a type of content previously exchanged between the device and the other device, and a time of a last exchange of content between the device and the other device.

15. In a device connected to an ad-hoc group of a network, a method comprising:
identifying one or more other devices in the ad-hoc group;
for each identified other device, accessing an encounter datastore storing encounter data representative of previous encounters of the device with other devices to determine an encounter history of the device with the identified other device; and
determining a disclosure factor to control a degree of obfuscation of content intended to be shared by the device with the ad-hoc group based on the encounter history of the one or more identified devices.

16. The method of claim 15 further comprising:
in response to an encounter with another device, updating the encounter datastore with at least one encounter statistic representing the encounter.

17. The method of claim 15 further comprising:
in response to detecting that a first other device has left the ad-hoc group, updating the disclosure factor based on the encounter history of the device with remaining other devices in the ad-hoc group.

18. The method of claim 17 further comprising:
in response to detecting that a second other device has joined the ad-hoc group:
accessing the encounter datastore to determine an encounter history for the second other device; and
updating the disclosure factor based on the encounter history for the second other device.

19. The method of claim 15 further comprising:
in response to detecting that another device has joined the ad-hoc group:
accessing the encounter datastore to determine an encounter history for the other device; and
updating the disclosure factor based on the encounter history for the other device.

20. The method of claim 15 further comprising:
at an application executed by the device:
identifying content to be shared with the ad-hoc group;
filtering the content based on the disclosure factor to generate filtered content; and
providing the filtered content for transmission to the ad-hoc group.
